(19) United States
(12) Patent Application Publication
(10) Pub. No.: US 2011/0313933 A1
(43) Pub. Date: Dec. 22, 2011

(54) Decision-Theoretic Control of Crowd-Sourced Workflows

(75) Inventors: Peng Dai, Seattle, WA (US); Mausam, Seattle, WA (US); Daniel S. Weld, Seattle, WA (US)

(73) Assignee: The University of Washington through its Center for Commercialization, Seattle, WA (US)

(21) Appl. No.: 13/049,769

(22) Filed: Mar. 16, 2011

Related U.S. Application Data
(60) Provisional application No. 61/314,516, filed on Mar. 16, 2010.
(60) Provisional application No. 61/441,550, filed on Feb. 10, 2011.

(51) Int. Cl. G06Q 10/00

(52) U.S. Cl. 705/301

(57) ABSTRACT

Systems and methods for the decision-theoretic control and optimization of crowd-sources workflows utilize a computing device to map a workflow to complete a directive. The directive includes a utility function, and the workflow comprises an ordered task set. Decision points precede and follow each task in the task set, and each decision point may require (a) posting a call for workers to complete instances of tasks in the task set; (b) adjusting parameters of tasks in the task set; or (c) submitting an artifact generated by a worker as output. The computing device accesses a plurality of workers having capability parameters that describe the workers' respective abilities to complete tasks. The computing device implements the workflow by optimizing and/or selecting user-preferred choices at decision points according to the utility function and submits an artifact as output. The computing device may also implement a training phase to ascertain worker capability parameters.

### CROSS-REFERENCE TO RELATED APPLICATIONS

This application claims priority to U.S. Provisional Application Ser. No. 61/314,516, filed Mar. 16, 2010, entitled “Decision-Theoretic Control of Crowd-Sourced Workflows,” and U.S. Provisional Application Ser. No. 61/441,550, filed Feb. 10, 2011, entitled “Decision-Theoretic Control of Crowd-Sourced Workflows,” both of which are herein incorporated by reference in their entirety.

### BACKGROUND

Crowd-sourcing is the act of taking tasks traditionally performed by an employee or contractor, and outsourcing them to a group (crowd) of people or community in the form of an open call, and it has the potential to revolutionize information-processing services by quickly coupling human workers with software automation in productive workflows. Like cloud computing, crowd-sourcing affords the ability to scale production extremely quickly due to the sheer number of global workers. While the phrase ‘crowd-sourcing’ was only termed in 2006, the area has grown rapidly in economic significance with the growth of general-purpose platforms such a Amazon's Mechanical Turk and task-specific sites for call centers and programming jobs. Indeed, crowd-sourcing has already revolutionized certain aspects of computer science research, e.g., the way labeled training data is acquired for machine learning and linguistics tasks, and it is having a growing impact on the execution of human-computer interaction (HCI) user studies.

Requesters use crowd-sourcing for a wide variety of jobs like dictation-transcription, content screening, linguistic tasks, user-studies, etc. These requesters often use complex workflows to subdivide a large task into bite-sized pieces (including the management of these tasks), each of which is independently crowd-sourced.

TurKit, the application programming interface (API) for executing tasks on Mechanical Turk, provides a high-level mechanism for defining moderately complex, iterative workflows with voting-controlled conditionals, but it does not have built in methods for monitoring the accuracy of workers; nor does TurKit automatically determine the ideal number of voters or estimate the appropriate number of iterations before returns diminish.

A partially-observable Markov decision process (POMDP) is a widely-used formulation that represents sequential decision problems under partial information. An agent tracks a set of probabilistic beliefs about the world's true state and faces the decision task of picking the best action to execute. Performing the action transitions the world to a new state and produces observations for the agent. The transitions between states are probabilistic and Markovian, i.e., the next state only depends on the current state and action. The state information is unknown to the agent, but she can infer a belief, the probability distribution of the current state, from observations.

### SUMMARY OF THE INVENTION

Unfortunately, incorporating crowd-sourcing into a complex workflow is difficult today. In order to request work from the crowd, a requester must decompose its job into appropriately sized pieces, manage the accuracy and performance of various workers, and finally combine the answers back into the workflow.

Systems and methods are disclosed herein for the decision-theoretic control and optimization of crowd-sources workflows (referred to hereinafter as TurKontrol). In one embodiment, a computing device maps a workflow to complete a directive. The directive includes an input specification, an output specification, and a utility function, and the workflow comprises an ordered task set. The task set comprises at least one task to be completed by at least one worker, and an artifact is generated when a worker completes an instance of a task. Decision points precede and follow each task in the task set, and each decision point may require (a) posting a call for workers to complete instances of tasks in the task set; (b) adjusting parameters of tasks in the task set; or (c) submitting an artifact generated by a worker as output. The computing device accesses a plurality of workers having capability parameters that describe the workers' respective abilities to complete tasks. The capability parameters are updated after workers complete instances of tasks. The computing device implements the workflow by optimizing and/or selecting user-preferred choices at decision points according to the utility function and based on availability of the plurality of workers, the capability parameters of the plurality of workers, and/or previously generated artifacts. The computing device submits an artifact as output. The computing device may also implement a training phase to ascertain capability parameters of workers.

### BRIEF DESCRIPTION OF THE DRAWINGS

FIG. 1 shows an iterative text improvement job workflow.

FIG. 2 summarizes the decision-theoretic control process for the workflow depicted in FIG. 1.

FIG. 3 shows the determined average net utility of TurKontrol (of Example 2) with various lookahead depths calculated using 10,000 simulation trials on three sets of (improvement, ballot) costs: (30,10), (3,1), and (0.3,0.1).

FIG. 4 shows the determined net utility of three control policies (of Example 2) averaged over 10,000 simulation trials, varying mean error coefficient, γ.

FIG. 5 presents a generative model of ballot tasks.

FIG. 6 shows the accuracies of using a ballot model (of Example 3) and majority vote on random voting sets with different size, averaged over 10,000 random sample sets for each size.

FIG. 7 shows average artifact qualities of 40 descriptions generated by TurKontrol (of Example 3) and by TurKit respectively, under the same monetary consumption.

FIG. 8 plots the average number of ballots per iteration number for TurKontrol (of Example 3) and TurKit.

FIG. 9 is a block diagram of an example computing device capable of implementing some embodiments.

### DETAILED DESCRIPTION

In some embodiments, a workflow is an ordered set of tasks. A task is a set of instructions to be presented to a worker to solicit the worker to generate an artifact. Each presentation of a task to a worker is an instance of the task. A worker may be paid for completing an instance of a task, and that payment may be referred to as the price or cost of the task or of the instance of the task. Multiple instances of the same task sent to different workers at the same time are referred to as a phase of the task. Phases of ordered tasks in a workflow are referred to as an iteration of those tasks.

Tasks may come in many different types and take many different forms. In some embodiments, tasks involve a worker generating complex content. Examples of such tasks include (i) writing or improving a description of a picture or other type of media; (ii) writing a review of a school, company, or other organization; (iii) transcribing an MP3 or other audio or video file; (iv) finding information on the World Wide Web or in physical world, such as the contact information for a person (e.g., the CEO of a company) or reviews of a product; (v) identifying products (e.g., software packages) which have requested functionality; (vi) evaluating the benefits and disadvantages of a product; (vii) categorizing a product; (viii) finding specifications of a product; (ix) getting the product name by serial number and manufacture name; and (x) breaking a task into sub-tasks.

In some embodiments, tasks may also require a worker to return Boolean values. Examples of such tasks include (i) determining if two entities are identical (e.g., are two E-commerce product pages referring to the same object); (ii) determining if a review or description is actually talking about a particular object X; (iii) deciding if A or B is better—e.g., a better description of an object or a better transcription; (iv) checking the existence of information on the World Wide Web; and (v) checking the answer to an equation

Alternatively or additionally, tasks may also require a worker to return ordinal data. Examples of such tasks include (i) ranking the quality of content (a picture, a description, a song) on a scale (e.g., 1 to 10); (ii) estimating the price of a product; (iii) estimating the number of errors in an artifact or piece of content; (iv) picking the best translations of a sentence; and (v) choosing all correct statements from a list of options.

In some embodiments, a directive is a description of a job that may be completed through the implementation of a crowd-sourced workflow. A directive may be a Partially Observable Markov Decision Process (POMDP) or may be modeled in a POMDP. In some embodiments, a directive includes an input specification, an output specification, and a utility function. The input specification describes the starting materials or assumptions of the job. The output specification describes characteristics of one or more desirable artifacts—content created by workers—that will be generated in order to complete the job. The utility function describes the relationship between an expected quality of an ultimate output artifact and aggregate task costs. Aggregate task costs are the costs paid to workers who are assigned instances of tasks to complete or to workers for completing instances of tasks over the course of implementing a workflow.

In some embodiments, a directive is generated by a crowd-sourcing requester. As an example, a requester may generate a directive for the job of captioning a picture. In such a situation, the input specification may be the picture to be captioned, and the output specification may be a description of the characteristics of a desired text caption for the picture—for example, that the caption be written in English, that it be of a certain length, or that it be in a certain style. The utility function may describe how much money the requester is willing to spend obtaining a suitable caption for the picture. A directive may include a workflow for completing the job. A directive may also be generated by a computing device in response to an informal request from a requester or other source.

Given the example of the picture-captioning job, a workflow may comprise a content task followed by an evaluation task. The content task may be instructions for a worker to follow in generating a caption for the picture. For example, an instance of the content task may present a worker with the picture and instruct the worker to write a caption for the picture. As another example, an instance of the content task may present a worker with the picture and a default caption or a caption written by another worker and request that the worker replace or revise the caption to create a better caption. The evaluation task may be instructions for a worker to following in evaluating captions for the picture. For example, an instance of the evaluation task may present a worker with the picture and two different captions and request that the worker vote for the better caption. As another example, an instance of the evaluation task may present a worker with the picture and a single caption and request that the worker rate the caption on a given scale.

In some embodiments, decision points precede and follow each task in an ordered task set, such that a workflow is comprised of tasks ordered and linked together through decision points. Each decision point may comprise a set of options available at that location of the workflow. Available options may include posting a call for workers to complete instances of tasks; adjusting parameters tasks; and submitting an artifact as output. A particular decision point may be visited multiple times during the implementation of a workflow. At each occurrence of the decision point, the same option as was chosen at a prior occurrence of the decision point may be chosen, or a different option may be chosen. If the same option is chosen at a new occurrence of a decision point, the particular parameters may be different. For example, at one occurrence of a decision point, a call may be posted to 50 workers to complete instances of a content task involving a first artifact. At the next occurrence of the same decision point, a call may be posted to 25 workers to complete instances of the content task involving a second artifact.

In the picture-captioning example, the workflow may include three decision points, a first before the content task, a second between the content task and the evaluation task, and a third after the evaluation task. Available options at each decision point may include posting a call for a number of workers to complete instances of the content task, posting a call for a number of workers to complete instances of the evaluation task, adjusting the cost of the content task, adjusting the cost of the evaluation task, changing the captions present in the content task, changing the captions presented in the evaluation task, or submitting a caption as output to the requester.

Decision points may include the option of changing parameters of tasks in the workflow. Take for example the directive of determining the best price for a primitive task. A workflow for that directive may include one content task—the primitive task, a first decision point before the content task and a second decision point after the content task. At the first decision point, it may be determined to post a call for a number of workers to complete instances of the content task an initial price. Those workers may then each complete the content task in a certain amount of time. At the second decision point, the response times from the workers completing instances of the content task may then be evaluated. If the response times are too long, the price of the content task may be increased from the initial price to provide increased incentive for workers to complete the content task. If the response times are too short, the price may be decreased from the initial price to avoid overpaying workers. Returning to the first decision point, another call could be posted for a number of workers to complete instances of the content task at the adjusted price. Additional iterations of the workflow could be performed until an optimal price was determined. Other examples of task parameters that may be adjustable at decision points include the format of presentation (the user interface presented to a worker) and the content of an instance of a task.

In addition to tasks to be performed by workers, a workflow may include functions to be performed by a computing device before or after instances of tasks to be completed by workers. As an example, assume a directive to find digital photos that are large and depict clean urban parks. A workflow for that directive may involve the computing device function of harvesting a collection of digital pictures of sufficient size. The workflow may then further involve the iterative task of presenting the harvested pictures to workers and requesting that workers decide whether each picture matches the description “clean urban park.” Further, the iterative task may be formatted in different ways—for example, a worker may be shown one picture at a time or an array of pictures all at once. In other examples, the computing device may have the ability to provide bonus payments to certain workers in certain situations (i.e., after multiple accurate task instance completions or after a quick instance completions). The possibility for such bonus payments may be incorporated into the workflow for optimization along with the worker-focused tasks.

In some embodiments, a workflow encompasses distinct subsets of tasks such that different sets of tasks are performed in different implementations of the workflow. For example, assume the directive to find the contact information for the CEO of a particular company. One subset of tasks to accomplish this directive may be to ask workers for contact information in one task and to ask workers whether they agree with previously generated contact information in a second task, selecting as an answer any contact information on which workers agree in the second task. Another subset of tasks may be to ask workers for contact information in one task and to ask a worker to use the contact information in the second task (e.g., to dial the phone number and report the name and affiliation of the person who answers), and to repeat those two tasks until the CEO is successfully contacted. A single workflow may encompass both of these alternative approaches.

In some embodiments, a computing device maps a directive to a workflow to complete. This mapping may involve receiving a directive from a requester or other source and creating a workflow of appropriate and ordered tasks to transform the input specification of the directive into the output specification of the directive according to the utility function of the directive. This mapping may also involve receiving a directive from a requester or other source that includes a workflow suitable for completing the directive.

In some embodiments, the computing device accesses a plurality of workers capable of performing tasks. These workers may be accessible to the computing device over an internal network (i.e., the workers may be individuals using other computing devices connected to the internal network), over the Internet (i.e., the workers may be users of an Internet accessible crowd-sourcing platform such as Mechanical Turk), or by other means.

Each worker in the plurality of workers may have at least one capability parameter that describes the worker's ability to complete tasks. Capability parameters may include error parameters or error distributions describing the likelihood of a worker to err when completing an instance of a task. Capability parameters may be task-type-specific or task-specific; for example, a content capability parameter may describe a worker's likelihood of erring when completing general content tasks, particular content tasks, or particular instances of content tasks, and an evaluation capability parameter may describe a worker's likelihood of erring when completing general evaluation tasks, particular evaluation tasks, or particular instances of evaluation tasks.

A worker's capability parameters may be updated after the worker completes an instance of a task. Updates may occur every time a worker completes any instance of any task or may occur periodically or occasionally. Updates may also occur to particular capability parameters after particular instances are completed. For example, a worker's content capability parameter may be updated every time a worker completes an instance of a content task.

Artifacts may have quality parameters that are descriptive of the artifact. For example, the quality parameter of an artifact may approximate the goodness of the artifact or the difficulty of improving the artifact in a content task. Additionally, a task may have a difficulty parameter that varies directly with the quality parameters of artifacts generated or evaluated prior to the task. The difficulty parameter of a task may impact how and the degree to which the capability parameter of a worker is updated after the worker completes an instance of the task.

The computing device may implement the workflow by optimizing and/or selecting user-preferred choices at decision points according to the utility function and based on availability of the plurality of workers, the capability parameters of the plurality of workers, and/or previously generated artifacts. In some embodiments, optimizing choices at decision points according to the utility function involves trading off a gain in long-term expected quality with an immediate cost incurred by choosing an option at a decision point.

In some embodiments, at the conclusion of an optimized implementation of the workflow, the computing device submits an artifact as output. In some embodiments, the artifact is generated by at least one worker completing at least one instance of at least one task in the set of ordered tasks in the workflow. The artifact may represent an acceptable level of quality given the aggregate costs spent implementing the workflow according to the utility function of the directive. In embodiments in which the directive was received from a requester, the output may be submitted to that requester.

In some embodiments, the computing device may implement a training phase. The training phase may involve all of the plurality of workers or may involve a subset of the plurality of workers. The purpose of the training phase may be to ascertain capability parameters for each worker using artifacts with known quality parameters and tasks with known difficulty parameters. The purpose of the training phase may also be to ascertain average capability parameters using artifacts with known quality parameters and tasks with known difficulty parameters. In the embodiments in which the training phase determines an average capability parameter, a worker without a history of completing tasks may be assigned a predetermined average capability parameter at the outset of that worker's participation in the completion of instances of tasks.

### I. Example 1

Example 1 covers the derivation of various models for evaluating the result of a vote, updating difficulties and worker accuracies, estimating utility, and controlling a basic workflow.

A. Evaluating Simple Votes

The most basic task for an intelligent agent is making a Boolean decision, which typically involves evaluating the probability of a hidden variable and using it to compute expected utility. For Example 1, the agent was TurKontrol and situated in an environment consisting of crowd-sourced workers, in which it evaluated the result of a vote. Example 1 began with this simple case, and later extended the discussion to handle utility and more complex scenarios. The Mechanical Turk framework is assumed; TurKontrol acts as the requester, submitting instances of tasks to one or more workers, x. The goal was to estimate the true answer, w, to a Boolean question (wε{1,0}).

Suppose that the agent has asked n workers to answer the question (giving them each an instance of a ballot task—each instance may be termed a ballot) and received answers, \vec{b}=b₁, . . . , bₙ, where bᵢε{1,0}. It is desirable to compute P(w|\vec{b}), i.e., the probability that the true answer is “Yes” (or “No”) given these ballots.

In order to accomplish this, some assumptions were necessary. First, it was assumed that each worker x is diligent, so she answers all ballots to the best of her ability. Still she may make mistakes, and a model of her accuracy may be learned. Second, it was assumed that several workers would not collaborate adversarially to defeat the system. These assumptions might lead one to believe that the probability distributions for worker responses (P (bi)) were independent of each other. Unfortunately, this independence is violated due to a subtlety. The reason was that even though the different workers were not collaborating, a mistake by one worker changed the error probability of others since the former gave evidence that the question may be intrinsically hard.

Intrinsic difficulty (d) of the question (dε[0,1]) was introduced. Given d, the probability distributions were assumed to be independent of each other. However, the assumption was complicating in that d as well as P(w|\vec{b}) needed to be estimated. Moreover, each worker's accuracy varied with the problem's difficulty. aₓ(d) was defined as the accuracy of the worker x on a question of difficulty d. Everyone's accuracy was assumed to be monotonically decreasing in d. The accuracies were assumed to approach random behavior as questions got really hard, i.e., aₓ(d)→0.5 as d→1.

Similarly, as d→0,aₓ(d)→1. A group of polynomial functions

$$\frac{1}{2} [ 1 + {( 1 - d )}^{{γ}_{x}} ] for {γ}_{x} > 0$$

was used to model aₓ(d) under these constraints. This polynomial function satisfied all the conditions when dε[0,1]. Note that smaller the γₓ the more concave the accuracy curve, and thus greater the expected accuracy for a fixed d. Using Bayes Theorem, the probability of the true answer may be derived given the ballots and the difficulty of the question:

$$\begin{matrix}P ( w = 1 \vert d , {b}^{->} ) ∝ P ( {b}^{->} \vert d , w = 1 ) P ( w = 1 \vert d ) & ( Equ . 1 ) \\ ∝ P ( {b}^{->} \vert d , w = 1 ) ( uniform prior on w ) & ( Equ . 2 ) \\ = {\prod }_{i} P ( {b}_{i} \vert d , w = 1 ) ( independence of workers ) & ( Equ . 3 )\end{matrix}$$

B. Updating Problem Difficulty & Worker Accuracies

P(bᵢ|d,w=1) was then computed directly using a worker's accuracy function—if bᵢ=1 then P(bi|d,w=1)=aₓ_{ᵢ}(d), else it is 1−aₓ_{ᵢ}(d). Because Equation 3 was a function in d, it was used to compute a maximum likelihood estimate for d, i.e., one that maximized P(\vec{b}|d,w), the probability of seeing the ballots:

$$\frac{\partial {\prod }_{i} P ( bi \vert d , w = 1 )}{\partial d} = 0 \qquad ( Equ . 4 )$$

It sufficed to condition on either of w=1 or w=0, since the same d that maximized one minimized the other. Because aₓ (d) was chosen from a family of polynomials Sturm's Theorem—a symbolic procedure to determine the number of distinct real roots of a polynomial—was used to find the optimal values. For embodiments using an alternative representation for aₓ(d), this equation may need to be solved for general functions. In such a case, gradient descent methods such as L-BFGS may be used. To minimize the problems of local minima, it may be useful to use random restarts.

After completing this ballot an estimate of the difficulty of the question, the true answer, and all the ballots were accessible. This information was used to update our record on the quality of each worker. In particular, if someone answered a question correctly then she was a good worker (and her γₓ decreased), and, if someone made an error in a question, her γₓ increased. Moreover, the increase/decrease amounts depended on the difficulty of the question. The following simple update strategy was implemented:

(1) If a worker answered a question of difficulty d correctly then γₓ←γₓ−dδ (the more difficult the question, the greater the decrease).
(2) If a worker made an error when answering a question then γₓ←γₓ+(1−d)δ (and vice versa).
δ was used to represent the learning rate, which slowly reduced over time so that the accuracy of a worker approaches an asymptotic distribution.

C. Evaluation & Extensions

After this model was implemented in simulation, it was tested to determine (1) whether the model indeed discovers correct answers most of the time (the difficulty values computed by the algorithm were tested as to whether they looked reasonable, e.g., by submitting extra Mechanical Turk jobs asking workers to estimate task difficulty using a Likert scale) (2) whether it passed stress tests: for instance, whether an easy question yielded a high probability with very few high-accuracy workers, but difficult problems required more votes. Similarly, if workers had low-accuracy, many more votes were likely needed to make a good judgment.

Workers may not always be diligent, and may even knowingly fool a system. Such a worker's accuracy does not approach one as difficulty approaches zero; rather, it may even approach zero in such cases. It may also approach another number if the worker is a random agent who likes to play such games only a fraction of the time. Therefore, in some embodiments, workers may need to be modeled by a more expressive accuracy function that will be learned over time automatically. Similarly, nonstationary distributions may need to be used to model workers whose behavior changes over time (e.g., initially diligent then becoming random to exploit employer trust).

D. Controlling Iterative-Improvement Workflows

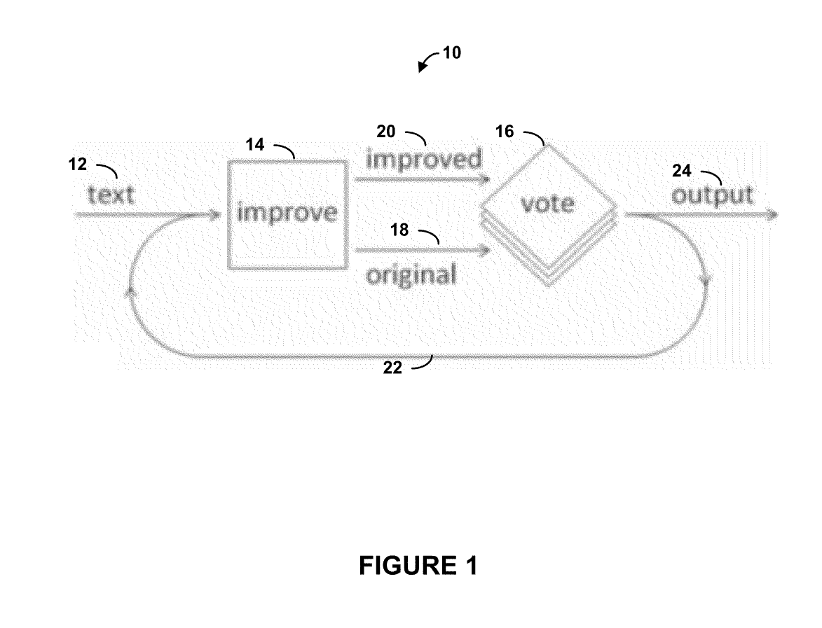

FIG. 1 depicts an iterative text improvement job workflow 10, which was used for Example 1 for two reasons. First, it is representative of a number of flows in actual commercial use today, such as CastingWords automatic dictation transcription service, which is one of the most frequent requesters on Mechanical Turk. Second, it demonstrates a moderately complex control flow with potentially dozens of component tasks.

The workflow assumes an initial task, which presents the worker with an image and requests an English description of the picture's contents. The text caption 12 resulting from the initial task is fed into the remainder of the workflow. A subsequent iterative process consists of an improvement task 14 and voting tasks 16.

Each time a worker is assigned or completes an improvement task or a voting task, that is considered an instance of the task. For each instance of the improvement task, a (different) worker is shown this same image as well as the current description and is requested to generate an improved English description. Both the caption presented to the worker in the improvement task 18 and the improved caption 20 are inputs for the voting takes 16. Next n≧1 instances of the ballot task are posted (“Which text best describes the picture?”) and evaluated in a manner similar to that of the previous section. The best description is kept—that is, presented to subsequent workers in subsequent improvement tasks through path 22—and the loop continues until a satisfactory output 24 is submitted. This iterative process generates better descriptions for a fixed amount than awarding the total reward to a single author. However, the workflow itself does not dictate many times should the loop be executed, how many voters should be asked to judge relative quality at each cycle, how should these two tasks should be traded off if money is tight, what the relative pay is for an instance of the improvement task vs. an instance of the ballot job.

E. Formulating Quality and Utility

In general, a requester will be willing to pay monotonically more for a description of increased quality. Indeed, utility may be encoded simply as a function from the quality of a description to its value in dollars. Moreover, the iterative improvement process can be used to increase the quality of any artifact, not just an English description. Intuitively, something is high quality if it is better than most things of the same type. For engineered artifacts (including English descriptions), something is high quality if it is difficult to improve. Therefore, in Example 1, the quality of an artifact is measured in terms of units called a quality improvement probability (QIP), denoted by qε[0,1]. An artifact with QIP q means an average dedicated worker has probability 1−q of improving the artifact. In Example 1, it was assumed that requesters express their utility as a function from QIP to dollars.

The QIP of an artifact is never exactly known—it is at best estimated based on domain dynamics and observations (like vote results). Thus, it is POMDP problem—the decisions need to be taken based on a belief of the QIP. Moreover, since QIP is a real number, it is a POMDP in continuous state space. These kinds of POMDPs are especially hard to solve for realistic problems. Performing a limited lookahead search may make planning more tractable.

F. Greedy Decision-Theoretic Control

The agent's control problem was defined as follows. As input, the agent was given an initial artifact (or a task description for requesting one), task descriptions for requesting an improvement and requesting a comparison, and a utility function U:QIP→R. The agent attempted to return an artifact which maximizes the payoff, which was U(q) minus the agent's payments to crowd-sourced workers.

Since each artifact's intrinsic QIP q was unknown, the agent's estimate of quality was denoted with the random variable, Q.

The iterative improvement process was an optimization problem. A decision point occurred when one task instance had just been finished. Generally, there were three possible actions to take at each decision point: (1) continue the current iteration by adding another instance of the ballot task, (2) update the current artifact and start a new iteration, and (3) submit the current best artifact. When the current artifact was updated, there were two strategies to take. The first one was memoryless, where the previous submission was discarded. The other, preferable approach was to keep a current best artifact. When one iteration was finished, the artifact provided in the current iteration was compared with the current best, and, when appropriate, the current best was updated with the better artifact.

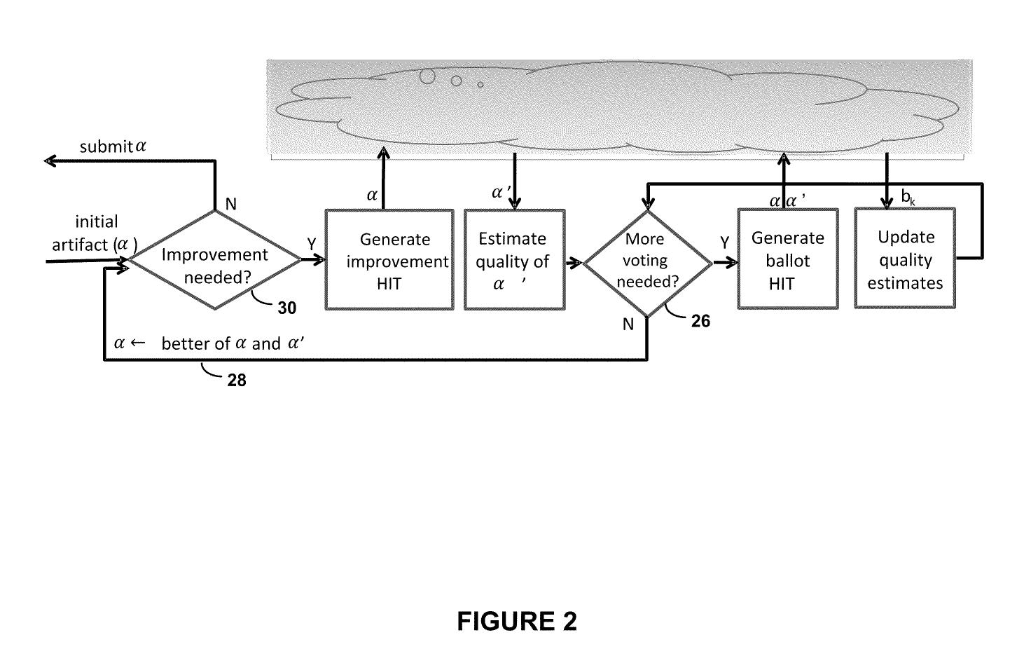

FIG. 2 summarizes the decision-theoretic control process for the workflow depicted in FIG. 1. To implement the process, the agent answered the following questions: (1) When to terminate the voting phase (thus switching attention to artifact improvement) (decision 26 in FIG. 2)? (2) Which of the two artifacts is the best basis for subsequent improvements (path 28 in FIG. 2)? (3) When to stop the whole iterative process and submit the result to the requester (decision 30 in FIG. 2)?

To answer these questions, the agent needed to compute several quantities, as discussed below: estimates, q and q′, of the qualities of the previous and current artifacts, α and α′, respectively, the delta utility of requesting an additional ballot job comparing α and α′, and an estimate of the total number of ballots which would be required to determine the best artifact if the agent were to request an improvement of α.

G. Estimating Artifact Quality

At all times, the agent maintained an estimate of the posterior distribution for the QIP of the previous artifact (ƒ_{Q|\vec{b}}) and the new one (ƒ_{Q′|\vec{b}}) given the voting results \vec{b}.

1. QIP prior for new artifact after improvement step:

An artifact α, with an unknown QIP q and a prior density function ƒ_{Q}(q) was assumed. It was further assumed that a worker x took an instance of an improvement task and submits another artifact α′ whose QIP was denoted by q′. Since α′ was a suggested improvement of α, q′ depended on the initial quality q. Moreover, a higher accuracy worker x may have improved it much more, so it depended on x. ƒ_{Q′|q,x} is defined as the conditional quality distribution of q′ when worker x improved an artifact of quality q. This distribution was estimated from actual data. With a known ƒ_{Q′|q,x} the prior on q′ was computed from the law of total probability:

ƒ_{Q′}(q′)=∫₀¹ƒ_{Q′|q,x}(q′)ƒ_{Q}(q)dq (Equ. 5)

2. QIP posterior after voting phase:

While priors existed on the QIPs of both the new and the old artifacts, it was unknown whether the new artifact was an improvement over the old or not. The worker may have done a good job or a bad job. Even if it was an improvement, there was a need to assess how good of an improvement it was. The workflow at this point gathered evidence to answer these questions by generating ballots (instances of the ballot task) and asking new workers a question: “Is α′ a better answer than α for the original question?” Based on the results of these ballots, ƒ_{Q|\vec{b}} and ƒ_{Q′|\vec{b}} were computed. These posteriors had three roles to play. First, more accurate beliefs lead to a higher probability of keeping the better artifact for subsequent phases. Second, within the voting phase confident beliefs helped decide when to stop voting. Third, a high QIP belief also helped decide when to quit the iterative process and submit.

3. Likelihood Computation for Each Voter:

Because the ballot question in consideration was a specific kind of vote, the true answer to the question (w) could be described completely in terms of two QIP values—q and q′. Thus w=1 (or “Yes”) if q′>q and w=0, otherwise.

Similarly d, the difficulty of the question, depended on whether the two QIPs are very close or not. The closer the two artifacts the more difficult it was to judge whether one was better or not. The relationship between the difficulty and QIPs was defined as

d(q,q′)=1−|q−q′|^{M} (Equ. 6)

Given this knowledge, the likelihood of a worker answering “Yes” was computed. The i^{th} worker xᵢ who has accuracy aₓ_{ᵢ}(d) was considered in order to calculate P(bᵢ=1|w,d), which could be completely described by P(bᵢ=1|q,q′).

If q>q′P(bᵢ=1|q,q′)=aₓ_{ᵢ}(d(q,q′))

If q≦q′P(bᵢ=1|q,q′)=1−aₓ_{ᵢ}(d(q,q′)), and so on (Equ. 7)

4. Posterior of α:

The posterior distribution ƒ_{Q|\vec{b}}(q) was derived. By applying the Bayes rule it became

ƒ_{Q|\vec{b}}(q)∝P(\vec{b}|q)ƒ_{Q}(q) (Equ. 8)

The law of total probability was applied on P(\vec{b}|q) and then the conditional independence of all workers:

$$\begin{matrix}P ( {b}^{->} \vert q ) = {\int }_{0}^{1} p ( {b}^{->} \vert q , {q}^{′} ) {f}_{{Q}^{′}} ( {q}^{′} ) d {q}^{′} \\ = {\int }_{0}^{1} {\prod }_{i} P ( {b}_{i} \vert q , {q}^{′} ) {f}_{{Q}^{′}} ( {q}^{′} ) d {q}^{′}\end{matrix} \qquad ( Equ . 9 )$$

Finally Equation 5 was applied to get

$${f}_{Q \vert {b}^{->}} ( q ) ∝ \{ {\int }_{0}^{1} {\prod }_{i} P ( {b}_{i} \vert q , {q}^{′} ) [ {\int }_{0}^{1} {f}_{{Q}^{′} \vert q , x} ( {q}^{′} ) {f}_{Q} ( q ) d q ] d {q}^{′} \} {f}_{Q} ( q ) \qquad ( Equ . 10 )$$

5. Posterior of α′:

Similarly, ƒ_{Q′|\vec{b}}(q′) was derived

$$\begin{matrix}{f}_{{Q}^{′} \vert {b}^{->}} ( {q}^{′} ) ∝ P ( {b}^{->} \vert {q}^{′} ) {f}_{{Q}^{′}} ( {q}^{′} ) & ( Equ . 11 ) \\ = [ {\int }_{0}^{1} P ( {b}^{->} \vert q , {q}^{′} ) {f}_{Q} ( q ) d q ] {f}_{{Q}^{′}} ( {q}^{′} ) & ( Equ . 12 ) \\ = [ {\int }_{0}^{1} {\prod }_{i} P ( {b}_{i} \vert q , {q}^{′} ) {f}_{Q} ( q ) d q ] & ( Equ . 13 ) \\ [ {\int }_{0}^{1} {{f}_{{Q}^{′} \vert q , x} ( q )}^{′} {f}_{Q} ( q ) d q ] & \end{matrix}$$

The quality of the previous artifact should change (posterior of α) based on ballots comparing it with the new artifact because if the improvement worker (who has a good accuracy) was unable to create a much better α′ in the improvement phase that must be because α already has a high QIP and was no longer easily improvable. Under such evidence, the QIP of α should have increased, which was reflected by the posterior of α,ƒ_{Q|\vec{b}}. Similarly, if all voting workers unanimously thought that α′ was much better than α, it meant the ballot was very easy, i.e., α′ incorporated significant improvements over α, and the QIPs should reflect that.

This computation helped determine the prior QIP for the artifact in the next iteration. It was either ƒ_{Q|\vec{b}} or ƒ_{Q′|\vec{b}} (Equations 10 and 13), depending on whether α or α′ was kept.

H. Estimating the Utility of an Additional Ballot

Next is the discussion of the computation guiding the decision of whether to request another ballot at a certain point. At that point, say, n ballots (\vec{bⁿ}) were already received and posteriors of the two artifacts ƒ_{Q}|\vec{b_{ⁿ}} and ƒ_{Q}′|\vec{b_{ⁿ}} were already available. U_{\vec{bn}} denotes the expected utility of stopping at that point, i.e., without another ballot and U_{\vec{bn+1}} denotes the utility after another ballot. \vec{bⁿ+1} symbolically denotes that n ballots were known, and another ballot (value currently unknown) may be received in the future. U_{\vec{bn}} was easily computed as the maximum expected utility obtainable from the two artifacts α and α′:

U_{\vec{bn}}=max{E[U(Q|\vec{bⁿ})],E[U(Q′|\vec{bⁿ})]}, where (Equ. 14)

E[U(Q|\vec{bⁿ})]=∫₀¹U(q)ƒ_{Q|\vec{bn}}(q)dq (Equ. 15)

E[U(Q′|\vec{bⁿ})]=∫₀¹U(q′)ƒ_{Q′|\vec{bn}}(q′)dq′ (Equ. 16)

Next, U_{\vec{bn}} was compared with the utility of taking an additional ballot, U_{\vec{bn+1}}. The n+1^{th} ballot, bⁿ+1, could be either “Yes” or “No”. The probability distribution P(bₙ₊₁|q,q′) governed this, which also depended on the accuracy of the worker (see Equation 7). However, since it was unknown which worker would take the ballot, anonymity was assumed and an average worker x̅ with the accuracy function a _{x̅}(d) was expected. Recall from Equation 6 that difficulty, d is a function of the similarity in QIPs: d(q,q′)=1−|q−q′|^{M}. Because q and q′ were not exactly known, the probability of getting the next ballot was computed by applying law of total probability on the joint probability ƒ_{Q,Q′}(q,q′):

P(bₙ₊₁)=∫₀¹[∫₀¹P(bₙ₊₁|q,q′)ƒ_{Q′|\vec{bn}}(q′)dq′]ƒ_{Q|\vec{bn}}(q)d (Equ. 17)

Which allowed computation of U_{\vec{bn+1}} as follows:

$$\begin{matrix}{U}_{\vec{{b}^{n} + 1}} = max \{ E [ U ( Q \vert \vec{{b}^{n} + 1} ) ] , E [ U ( {Q}^{′} \vert \vec{{b}^{n} + 1} ) ] \} where & ( Equ . 18 ) \\ E [ U ( Q \vert \vec{{b}^{n} + 1} ) ] = {\int }_{0}^{1} ( {\sum }_{{b}_{n + 1}} U ( q ) {f}_{Q \vert \vec{{b}^{n + 1}}} ( q ) P ( {b}_{n + 1} ) ) d q & ( Equ . 19 )\end{matrix}$$

Here the summation was over the two possible results of the next ballot. The equation for E[U(Q|\vec{bⁿ+1})] mimicked Equation 19. After both U_{\vec{bn}} and U_{\vec{bn+1}} were computed, the expected utility gain from another ballot was known. The additional ballot was asked for only when the expected utility gain exceeded the cost of a ballot (c_{b}), i.e., U_{\vec{bn+1}}−U_{\vec{bn}}>c_{b}. A decision to stop meant that the artifact carried forward was the one that gave better utility, i.e., arg max(E[U(Q|\vec{bⁿ})],E[U(Q′|\vec{bⁿ})]). Moreover, one of ƒ_{Q|\vec{bn}} and ƒ_{Q′|\vec{bn}} was the prior ƒ_{Q}(q) for the next iteration.

I. Estimating the Number of Ballots in the Next Iteration

To make a utility-theoretic decision of whether to stop at an artifact or attempt another improvement step, the expected cost of an improvement iteration followed by a voting phase needed to be computed. To obtain this, the expected number of ballots in an iteration was computed. This computation was very similar to the previous subsection except that previously only one vote in the future was considered, whereas this time an expectation over many votes in the future was computed.

Uₙ denoted the expected utility from an iteration with exactly n ballots, where none of the ballot results were currently known. Notice that this differed from U_{\vec{bn}} of the previous section since here all these n ballots were in the future. Uₙ was the maximum expected utility from two artifacts α and α′, with QIP density conditioned on n future ballots, here denoted by ƒ_{Q|n} and ƒ_{Q′|n} respectively.

Uₙ=max{E[U(Q|n)],E[U(Q′|n)]} where (Equ. 20)

E[U(Q|n)]=∫₀¹U(q)ƒ_{q|n}(q)dq (Equ. 21)

To calculate ƒ_{Q|n} (and similarly ƒ_{Q′|n}) the law of total probability was used:

$${f}_{Q \vert n} ( q ) = {\sum }_{all \vec{{b}^{n}}} {f}_{Q \vert \vec{{b}^{n}}} ( q ) P ( \vec{{b}^{n}} ) \qquad ( Equ . 22 )$$

ƒ_{Q|\vec{bn}}(q) was computed (see Equation 10). To compute P(\vec{bⁿ}), the law of total probability on the joint probability ƒ_{Q,Q′}(q,q′) (similar to Equation 17) was applied to:

P(\vec{bⁿ})=∫₀¹[∫₀¹P(\vec{bⁿ}|q,q′)ƒ_{Q′|q, x̅}(q′)dq′]ƒ_{Q}(q)dq (Equ. 23)

As before, it was assumed that an average worker x̅ would be encountered. Also note that the order of the ballots did not matter in this computation, so the multinomial distribution collapsed into a binomial. In implementation, only n+1 unique terms needed to be considered in Equation 22.

The voting process was stopped after k ballots if adding another ballot decreased the expected utility; this translated to Equation 24:

Uₖ₊₁−Uₖ<c_{b} (Equ. 24)

where c_{b} was the cost of paying a worker to perform a ballot.

The expected number of ballots, n_{b}*, was the minimum integer k that satisfied the inequality above. n_{b}* was computed by iteratively calculating U₁, U₂, . . . , until Equation 24 was satisfied.

J. When to Terminate an Iteration?

At this point, final decision problem could be answered—whether to start a new iteration or submit the current artifact (α). For this, QIP of α was accessible. The computation above estimated an expected number of ballots in the improvement phase. So the total cost of another iteration was cᵢₘₚ+n_{b}*c_{b}. Here cᵢₘₚ was the cost of an improvement instance. If the expected utility gain outweighed the cost, another iteration was performed.

The expected utility of submitting α at this point, U_{now}, was ∫₀¹U(q)ƒ_{Q}(q)dq. The expected utility of submitting a better artifact after an improvement and n_{b}* ballots was U_{n*}_{_{b}} computed in Equation 20 above. U_{n*}_{_{b}}−U_{now}>cᵢₘₚ+n*_{b}c_{b} dictated that another iteration was initiated, else the process was terminated.

K. Updating Worker Accuracies

After each interaction with workers, the agent updated its database of voter accuracies using a method similar to the scheme described above. The only difference was that d needed to be computed, however, d depended on the exact values for q and q′, which were not accessible. Instead the agent estimates d based on its estimates of these QIPs as follows:

d*=∫₀¹∫₀¹d(q,q′)ƒ_{Q}(q)ƒ_{Q′}(q′)dqdq′=∫₀¹∫₀¹(1−|q,q′|^{M})ƒ_{Q}(q)ƒ_{Q′}(q′)dqdq′ (Equ. 25)

Using d* the agent used the approach described above to update the estimates for voter accuracies. It also updated its model of improvement-workers.

L. Implementation

In a general model, maintaining a closed form representation for all these continuous functions may not be possible. Uniform discretization is the simplest way to approximate these general functions. However, for efficient storage and computation TurKontrol employed the piecewise constant/piecewise linear value function representations or use particle filters.

Updates in the posteriors of q and q′ were best implemented incrementally. For instance, instead of using Equation 10 directly, the posterior of α after n+1^{th} ballot (ƒ_{Q|\vec{bn+1}}) was updated using the posterior after the n^{th} ballot as a prior, in Equation 26:

ƒ_{Q|\vec{bn+1}}(q)∝[∫₀¹P(bₙ₊₁|q,q′)ƒ_{Q′|\vec{bn}}(q′)dq′]ƒ_{Q|\vec{bn}} (Equ. 26)

### II. Example 2

Example 2 is a set of experiments that was undertaken to empirically determine (1) how deep an agent's lookahead should be to best tradeoff between computation time and utility, (2) whether the TurKontrol agent made better decisions compared to TurKit and (3) whether the TurKontrol agent outperformed an agent following a well-informed, fixed policy.

A. Experimental Setup.

The maximum utility was set to be 1000 and a convex utility function was used

$$U ( q ) = 1000 \frac{{e}^{q} - 1}{e - 1} \qquad ( Equ . 27 )$$

with U(0)=0 and U(1)=1000. It was assumed that the quality of the initial artifact followed a Beta distribution, which implied that the mean QIP of the first artifact was 0.1. Given that the quality of the current artifact was q, it was assumed that the conditional distribution ƒ_{Q′|q,x} was Beta distributed, with mean μ_{Q′|q,x} where:

μ_{Q′|q,x}=q+0.5[(1−q)×(aₓ(q)−0.5)+q×(aₓ(q)−1)] (Equ. 28)

and the conditional distribution was Beta (10μ_{Q′|q,x},10(1−μ_{Q′|q,x})). A higher QIP meant that it was less likely that the artifact could be improved. The results of an improvement task were modeled in a manner akin to ballot tasks; the resulting distribution of qualities was influenced by the worker's accuracy and the improvement difficulty, d=q.

The ratio of the costs of improvements and ballots was fixed,

$$\frac{{c}_{imp}}{{c}_{b}} = 3 ,$$

because ballots take less time. The difficulty constant was set M=0.5. In each of the simulation runs, a pool of 1000 workers was built, whose error coefficients, γₓ, followed a bell shaped distribution with a fixed mean γ. The accuracies of performing an improvement and answering a ballot were distinguished by using one half of γₓ when worker x was answering a ballot, since answering a ballot was an easier task, and therefore a worker should have had higher accuracy.

B. Picking the Best Lookahead Depth.

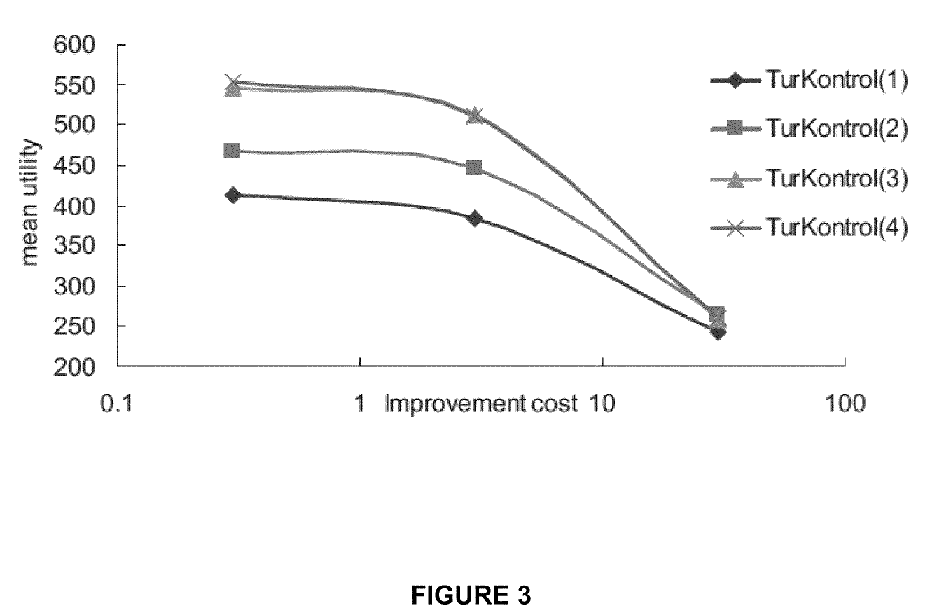

10,000 simulation trials were run with average error coefficient γ=1 on three pairs of improvement and ballot costs—(30,10), (3,1),and (0.3,0.1)—trying to find the best lookahead depth l for TurKontrol. FIG. 3 shows the average net utility, the utility of the submitted artifact minus the payment to the workers, of TurKontrol with different lookahead depths, denoted by TurKontrol(l). There was always a performance gap between TurKontrol(1) and TurKontrol(2), but the curves of TurKontrol(3) and TurKontrol(4) generally overlapped. When the costs were high, such that the process usually finished in a few iterations, the performance difference between TurKontrol(2) and deeper step lookaheads was negligible. Since each additional step of lookahead increased the computational overhead by an order of magnitude, TurKontrol's lookahead was limited to depth 2 in subsequent experiments.

C. The Effect of Poor Workers.

The effect of worker accuracy on the effectiveness of agent control policies was next considered. Using fixed costs of (30,10), the average net utility of three control policies were compared. The first was TurKontrol(2). The second, TurKit, was a fixed policy from the literature; it performed as many iterations as possible until its fixed allowance (400 in our experiment) was depleted and on each iteration it did at least two ballots, invoking a third only if the first two disagreed. The third policy, TurKontrol(fixed), combined elements from decision theory with a fixed policy. After simulating the behavior of TurKontrol(2), the integer mean number of iterations, μᵢₘₚ, and mean number of ballots, μ_{b}, were computed and these values were used to drive a fixed control policy (μᵢₘₚ iterations each with μ_{b} ballots), whose parameters were tuned to worker fees and accuracies.

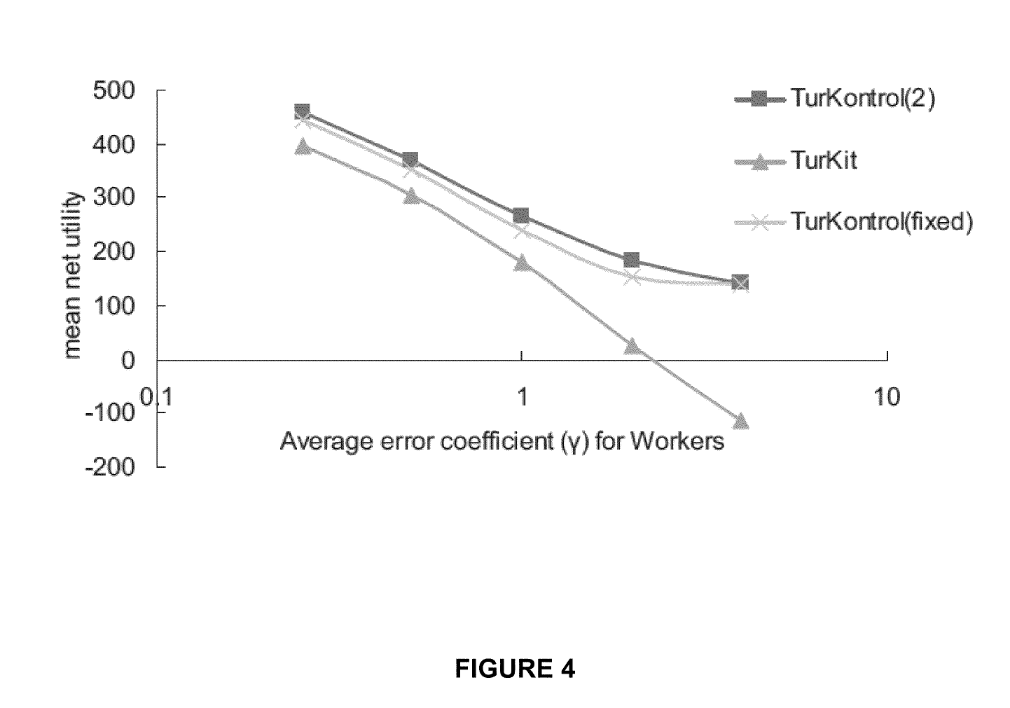

FIG. 4 shows that both decision-theoretic methods worked better than the TurKit policy, partly because TurKit ran more iterations than needed. A Student's t-test showed that all differences were statistically significant with p value 0.01. The performance of TurKontrol(fixed) was very similar to that of TurKontrol(2), when workers were very inaccurate, γ=4. Indeed, in this case TurKontrol(2) executed a nearly fixed policy itself In all other cases, however, TurKontrol(fixed) consistently underperformed TurKontrol(2). A Student's t-test results confirmed that the differences were all statistically significant for γ<4. This difference may be attributed to the fact that the dynamic policy made better use of ballots, e.g., it requested more ballots in late iterations, when the (harder) improvement tasks were more error-prone. The biggest performance gap between the two policies manifested when γ=2, where TurKontrol(2) generated 19.7% more utility than TurKontrol(fixed).

D. Robustness in the Face of Bad Voters.

As a final study, the sensitivity of the previous three policies to increasingly noisy voters was considered. Specifically, the previous experiment was repeated using the same error coefficient, γₓ, for each worker's improvement and ballot behavior. (Recall that previously the error coefficient for ballots was set to one half γₓ to model the fact that voting is easier.) The resulting graph had the same shape as that of FIG. 4 but with lower overall utility. Once again, TurKontrol(2) continued to achieve the highest average net utility across all settings. Interestingly, the utility gap between the two TurKontrol variants and TurKit was consistently bigger for all γ than in the previous experiment. In addition, when γ=1, TurKontrol(2) generated 25% more utility than TurKontrol(fixed)—a bigger gap than was seen in the previous experiment. A Student's t-test showed that all the differences between TurKontrol(2) and TurKontrol(fixed) were significant when γ<2 and the differences between both TurKontrol variants and TurKit were significant at all settings.

### III. Example 3

Example 3 addresses learning ballot and improvement models for an iterative improvement workflow, such as the one shown in FIG. 1. In this workflow, the work created by the first worker goes through several improvement iterations; each iteration comprising an improvement and a ballot phase. In the improvement phase, an instance of the improvement task solicits α′, an improvement of the current artifact α (e.g., the current image description). In the ballot phase, several workers respond to instances of a ballot task, in which they vote on the better of the two artifacts (the current one and its improvement). Based on majority vote, the better one is chosen as the current artifact for next iteration. This process repeats until the total cost allocated to the particular task is exhausted.

There are various decision points in executing an iterative improvement process, such as which artifact to select, when to start a new improvement iteration, when to terminate the job. For the purposes of Example 3, TurKontrol was a POMDP-based agent that controlled the workflow, i.e., made these decisions automatically. The world state included the quality of the current artifact, qε[0,1], and q′ of the improved artifact; true q and q′ were hidden, and the controller could only track a belief about them. Intuitively, the extreme value of 0 (or 1) represented the idealized condition that all (or no) diligent workers would be able to improve the artifact. Q and Q′ denoted the random variables that generate q and q′. Different workers may have had different skills in improving an artifact. A conditional distribution function, ƒ_{Q′|q}, expressed the probability density of the quality of a new artifact when an artifact of quality q was improved by worker x. The worker-independent distribution function, ƒ_{Q′|q}, acted as a prior in cases where a previously unseen worker was encountered. The ballot task compared two artifacts; intuitively, if the two artifacts have qualities close to each other then the particular instance of the ballot task was harder. The intrinsic difficulty of an instance of the ballot task was defined as d(q,q′)=1−|q−q′|^{M}. Given the difficulty d, ballots of two workers were conditionally independent to each other. The accuracy of worker x was assumed to be as follows:

$$a ( d , {γ}_{x} ) = \frac{1}{2} [ 1 + {( 1 - d )}^{{γ}_{x}} ] \qquad ( Equ . 29 )$$

where γₓ was x's error parameter; a higher γₓ signified that x made more errors.

A. Model Learning

In order to estimate TurKontrol's POMDP model, there were two probabilistic transition functions to learn. The first function was the probability of a worker x answering a ballot question correctly, which was controlled by the error parameter γₓ of the worker. The second function estimated the quality of an improvement result, the new artifact returned by a worker.

1. Learning the Ballot Model

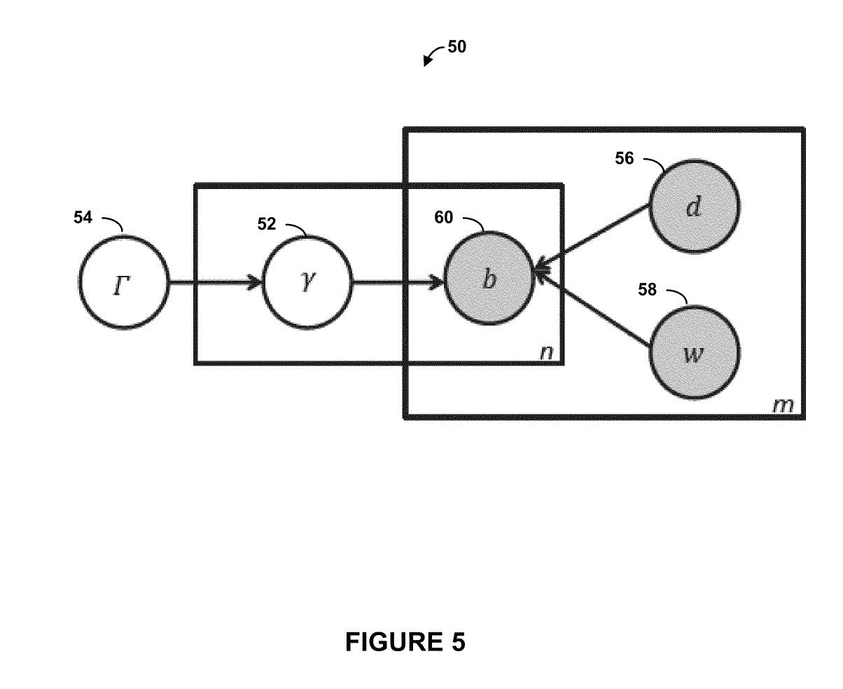

FIG. 5 presents a generative model 50 of ballot tasks; shaded variables were observed. Over the course of Example 3, the following parameters were learned: the error parameters \vec{γ} (learned variable 52 in FIG. 5), where γₓ was parameter for the x^{th} worker, and the mean γ̅, as an estimate for future, unseen workers. To generate training data, m pairs of artifacts were selected and n instances of a ballot task were posted, each of which asked the workers to choose between these pairs. b_{i,x} denoted x^{th} worker's ballot on the i^{th} question. Let wᵢ=true(false) if the first artifact of the i^{th} pair was (not) better than the second, and dᵢ denoted the difficulty of answering such a question.

The error parameters were assumed to be generated by a random variable Γ (assumed variable 54 on FIG. 5). The ballot answer of each worker directly depended on her error parameter, as well as the difficulty of the job, d (observed variable 56 on FIG. 5), and its real truth value, w (observed variable 58 on FIG. 5). w and d were collected for the m ballot questions from a consensus of three human experts and treated as observed. In Example 3, a uniform prior of Γ was assumed, though the model could incorporate more informed priors. The standard maximum likelihood approach was used to estimate γₓ parameters. b_{i,x} denotes x^{th} worker's ballot on the i^{th} question (and id depicting generally as observed variable 60 in FIG. 5) and {right arrow over (\vec{b} denotes all ballots.

P(\vec{γ}|{right arrow over (\vec{b},\vec{w},\vec{d})∝P(\vec{γ})P({right arrow over (\vec{b}|\vec{γ}\vec{,w},\vec{d}) (Equ. 30)

Under the uniform prior of Γ and conditional independence of different workers given difficulty and truth value of the task, Equation 30 can be simplified to

P(\vec{γ}|{right arrow over (\vec{b},\vec{w}, \vec{d})∝P({right arrow over (\vec{b}|\vec{γ}\vec{,w},\vec{d}) (Equ. 31)

=Πᵢ₌₁^{m}Πₓ₌₁ⁿP(b_{i,x}|γₓ,dᵢ,wᵢ) (Equ. 32)

Constants: d₁, . . . , d_{w}, w₁, . . . , w_{b}, b₁₁, . . . , b_{m,n}
Variables: γ₁, . . . γₙ,

### Maximize:

Σᵢ₌₁^{m}Σₓ₌₁ⁿ log [P(b_{i,x}|γₓ,dᵢ,wᵢ)] (Equ. 33)

### Subject to: Ø

2. Experiments on Ballot Model

The effectiveness of the learning procedure was evaluated on the image description task. 20 pairs of images were selected (m=20), and ballots were collected from 50 workers. Spammers were detected and dropped (n=45). $4.50 was spent to collect this data. The optimization problem was solved using the NLopt package, available through MIT at ab-initio.mit.edu/wiki/index.php/Nlopt.

Once the error parameters were learned, they were evaluated in a five-fold cross-validation experiment as follows: take ⅘th of the images and learn error parameters over them; use these parameters to estimate the true ballot answer (\tilde{w}ᵢ) for the images in the fifth fold. The cross-validation experiment obtained an accuracy of 80.01%, which is barely different from a simple majority baseline (with 80% accuracy). Indeed, the four ballots frequently missed by the models were those in which the mass opinion differed from the expert labels.

The confidence, degree of belief in the correctness of an answer, was compared for the two approaches. For the majority vote, the confidence was calculated by taking the ratio of the votes with the correct answer and the total number of votes. For the model, the average posterior probability of the correct answer was used. The average confidence values of using the ballot model were much higher than the majority vote (82.2% against 63.6%). This showed that even though the two approaches achieve the same accuracy on all 45 votes, the ballot model has superior belief in its answer.

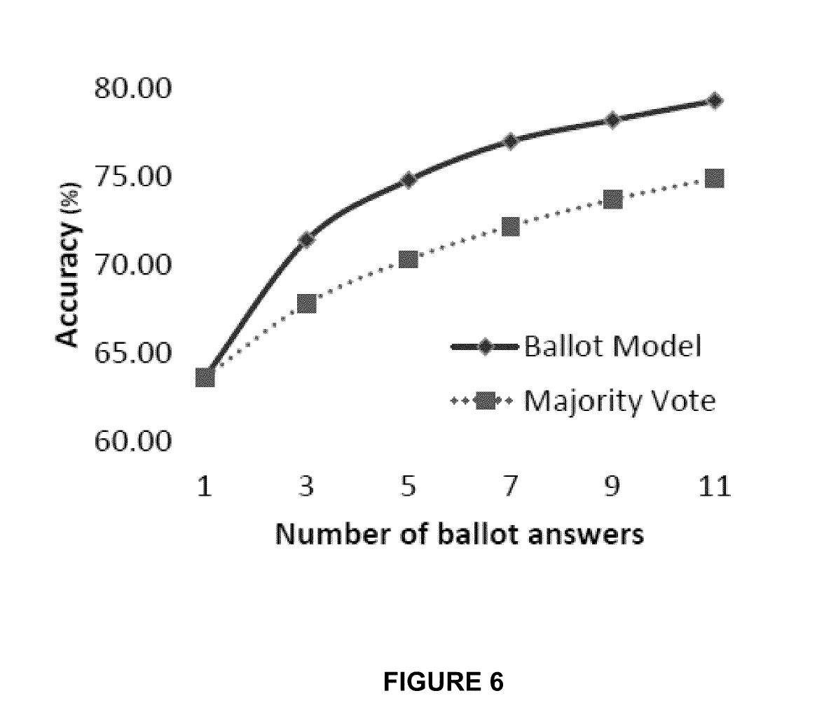

However, one will rarely have the resources to doublecheck each question by 45 voters, so Example 3 progressed by varying the number of available voters. For each image pair, 50,000 sets of 3-11 ballots were randomly sampled and the average accuracies of the two approaches were computed. FIG. 6 shows the accuracies of using the ballot model and majority vote on random voting sets with different size, averaged over 10,000 random sample sets for each size. FIG. 6 also shows that the model consistently outperforms the majority vote baseline: the ballot model achieved significantly higher accuracy than the majority vote (p<0.01).

With just 11 votes, the model was able to achieve an accuracy of 79.3%, which was very close to that using all 45 votes. Also, the ballot model with only 5 votes achieved similar accuracy as a majority vote with 11. This showed the value of the ballot model—it significantly reduced the amount of votes needed for the same desired accuracy.

3. Estimating Artifact Quality

In order to learn the effect of a worker trying to improve an artifact, labeled training data was needed, and that meant determining the quality of an arbitrary artifact. The quality of an artifact is defined to be the probability that an average diligent worker can successfully improve it. Thus, an artifact with quality 0.5 is just as likely to be hurt by an improvement attempt as actually enhanced. Since quality is a partially-observable statistical measure, three ways to approximate it were considered: simulating the definition, direct expert estimation, and averaged worker estimation.

The first technique simply simulated the definition. k workers were asked to improve an artifact α and as before used multiple ballots, say l, to judge each improvement. The quality of α is defined to be 1 minus the fraction of workers that are able to improve it. This method required k+kl jobs in order to estimate the quality of a single artifact; thus, it was both slow and expensive in practice. As an alternative, direct expert estimation was less complex. A statistically-sophisticated computer scientist was taught the definition of quality and asked to estimate the quality to the nearest decile. The final method, averaged worker estimation, was similar, but averaged the judgments from several Mechanical Turk workers via scoring tasks. These scoring tasks provided a definition of quality along with a few examples; the workers were then asked to score several more artifacts.

4. Experimental Observations

Data on 10 images from the Web was collected, and Mechanical Turk was used to generate multiple descriptions for each. One description for each image was selected, such that the chosen descriptions spanned a wide range of detail and language fluency. A description was modified to obtain one that was very hard to improve, thereby accounting for the high quality region. When simulating the definition, the average over k=22 workers was taken. (24 sets of improvements were collected, but two workers improved less than 3 artifacts, so they were tagged as spammers and dropped from the analysis.) A single expert was used for direct expert estimation, and an average of 10 worker scored for averaged worker estimation.

All three methods produced similar results. They agreed on the two best and worst artifacts, and on average both expert and worker estimates were within 0.1 of the score produced by simulating the definition. Averaged worker estimation was equally effective and additionally easier and more economical (1 cent per scoring task).

5. Learning the Improvement Model

A model was learned for the improvement phase. The objective was to estimate the quality q′ of a new artifact, α′, when worker x improves artifact α of quality q. This was represented using a conditional probability density function ƒ_{Q′}_{ₓ}_{|q}. Moreover, a prior distribution, ƒ_{Q′|q}, was learned to model work by a previously unseen worker.

There are two main challenges in learning this model: first, these functions were over a two-dimensional continuous space, and second, the training data was scant and noisy. To alleviate the difficulties, the task was broken into two learning steps: (1) a mean value was learned for quality using regression, and (2) a conditional density function was fit given the mean. The second learning task was made tractable by choosing parametric representations for these functions. The full solution followed the following steps:

(1) Generated an improvement job that contains u original artifacts α₁, . . . , αᵤ.
(2) Crowd-sourced ν workers to improve each artifact to generate uν new artifacts.
(3) Estimated the qualities q₁ and q′_{i,x} for all artifacts in the set (see previous section). qᵢ is the quality of αᵢ and q′_{i,x} denotes the quality of the new artifact produced by worker x. These acted as training data.
(4) Learned a worker-dependent distribution ƒ_{Q′}_{ₓ}_{|q} for every participating worker x.
(5) Learned a worker-independent distribution ƒ_{Q′|q} to act as a prior on unseen workers.
The last two steps are described in detail. The mean of worker x's improvement distribution was first estimated, and denoted by μ_{Q′}_{ₓ}(q).

μ_{Q′}_{ₓ} was assumed to be a linear function of the quality of the original artifact, i.e., the mean quality of the new artifact linearly increases with the quality of the original one. (While this was an approximation, it was surprisingly close; R²=0.82 for the worker-independent model.) By introducing μ_{Q′}_{ₓ}, the variance in a worker's ability in improving all artifacts of the same quality was separated from the variance in the training data, which was due to her starting out from artifacts of different qualities. To learn this, a linear regression was performed on the training data (qᵢ,q′_{i,x}). This yielded q′ₓ=aₓq+bₓ as the line of regression with standard error eₓ, which was truncated for values outside [0, 1].

To model a worker's variance when improving artifacts with the same quality, three parametric representations were considered for ƒ_{Q′}_{ₓ}_{|q}:Triangular, Beta, and Truncated Normal. While clearly making an approximation, restricting attention to these distributions significantly reduced the parameter space and made the learning problem tractable. Note that the mean, \hat{μ}_{Q′}_{ₓ}(q) of each of these distributions was assumed to be given by the line of regression, aₓq+bₓ. Each distribution was considered in turn.

a. Triangular:

The triangular-shaped probability density function has two fixed vertices (0,0) and (1,0). The third vertex was set to \hat{μ}_{Q′}_{ₓ}(q), yielding the following density function:

$${f}_{{Q}_{x}^{′} \vert q} ( {q}_{x}^{′} ) = \{ \begin{matrix}\frac{2 {q}_{x}^{′}}{{\hat{μ}}_{{Q}_{x}^{′}} ( q )} & if {q}_{x}^{′} < {\hat{μ}}_{{Q}_{x}^{′}} ( q ) \\ \frac{2 ( 1 - {q}_{x}^{′} )}{1 - {\hat{μ}}_{{Q}_{x}^{′}} ( q )} & if {q}_{x}^{′} \geq {\hat{μ}}_{{Q}_{x}^{′}} ( q )\end{matrix} \qquad ( Equ . 34 )$$

b. Beta:

The Beta distribution's mean was assumed to be \hat{μ}_{Q′}_{ₓ} and its standard deviation to be proportional to eₓ. Therefore, a constant, c₁, was trained using gradient descent that maximized the log-likelihood of observing the training data for worker x. (Newton's method was used with 1000 random restarts. Initial values were chosen uniformly from the real interval (0, 100.0).) This resulted in

$${f}_{{Q}_{x}^{′} \vert q} = Beta ( \frac{{c}_{1}}{{e}_{x}} \times {\hat{μ}}_{{Q}_{x}^{′}} ( q ) , \frac{{c}_{1}}{{e}_{x}} \times ( 1 - {\hat{μ}}_{{Q}_{x}^{′}} ( q ) ) ) \qquad ( Equ . 35 )$$

The error eₓ appeared in the denominator because the two parameters for the Beta distribution were approximately inversely related to its standard deviation.

c. Truncated Normal:

As before, the mean was set to \hat{μ}_{Q′}_{ₓ} and the standard deviation to c₂×eₓ where c₂ was a constant, trained to maximize the log likelihood of the training data. This yielded

ƒ_{Q′}_{ₓ}_{|q}=Truncated Normal(\hat{μ}_{Q′}_{ₓ}(q),c₂²eₓ²) (Equ. 36)

where the truncated interval was [0, 1].

Similar approaches were used to learn the worker-independent model ƒ_{Q′|q}, except that training data was of the form (qᵢ,q′ᵢ) where q; was the average improved quality for i^{th} artifact, i.e., the mean of q′_{i,x} (over all workers). The standard deviation of this set was for σ_{Q′}_{ᵢ}_{|q}_{ᵢ}. As before, the linear regression was assumed to be q′=aq+b. The Triangular distribution was defined exactly as before. For the other two distributions, their standard deviations depended on the conditional standard deviations for σ_{Q′}_{ᵢ}_{|q}_{ᵢ}. Here, the conditional standard deviation for σ_{Q′|q} was assumed to be quadratic in q, therefore an unknown conditional standard deviation given any quality qε[0,1] can be inferred from existing ones for σ_{Q′}_{₁}_{|q}_{₁}, . . . , for σ_{Q′}_{_{ν}}_{|q}_{_{ν}} using quadratic regression. As before, gradient descent was used to train variables c₃ and c₄ for Beta and Truncated Normal respectively.

d. Experimental Observations

To determine which of the three distributions best models the data, leave-one-out cross validation was employed. The number of original artifacts and number of workers were set to be ten each. This data collection cost a total of $16.50. The algorithm iteratively trained on nine training examples, e.g. {(qᵢ, q̅′̅ᵢ̅)} for the worker-independent case, and measured the probability density of observing the tenth. The model was scored by summing the ten log probability densities.

The results showed that Beta distribution with c₁=3.76 was the best conditional distribution for worker-dependent models. For the worker-independent model, Truncated Normal with c₄=1.00 performed the best. This was likely the case because most workers have average performance, and Truncated Normal has a thinner tail than the Beta. In all cases, the Triangular distribution performed worst. This was probably because Triangular assumes a linear probability density, whereas, in reality, workers tend to provide reasonably consistent results, which translates to higher probabilities around the conditional mean.

B. Results of Example 3—TurKontrol on Mechanical Turk

Having learned the POMDP parameters, the final evaluation assessed the benefits of the dynamic workflow controlled by TurKontrol versus a static workflow (as originally used in TurKit) under similar settings, specifically using the same monetary consumption. The following questions were answered: (1) Is there a significant quality difference between artifacts produced using TurKontrol and TurKit? (2) What are the qualitative differences between the two workflows?

As before, the model was evaluated on the image description task, in particular, 40 fresh pictures from the Web were used and iterative improvement was employed to generate descriptions for these. For each picture, a worker was restricted to taking part in at most one iteration in each setting (i.e., static or dynamic). The user interfaces were set to be identical for both settings, and the order in which the two conditions were presented to workers was randomized in order to eliminate human learning effects. Altogether there were 655 participating workers, of which 57 took part in both settings.

Automated rules were devised to detect spammers. An instance of an improvement task was rejected if the new artifact was identical to the original. Instances of ballot and scoring tasks were rejected if they were returned so quickly that the worker could not have made a reasonable judgment.

The system of Example 3, TurKontrol, did not need to learn a model for a new worker before assigning that worker instances of tasks; instead, it used the worker-independent parameters γ̅ and ƒ_{Q′|q} as a prior. These parameters were incrementally updated as TurKontrol obtained more information about their accuracy.

TurKontrol performed decision-theoretic control based on a user-defined utility function. U(q)=$25q was used for the experiments of Example 3. The cost of an instance of the improvement task was set to be 5 cents and that of an instance of the ballot task to be 1 cent. A limited-lookahead algorithm was used for the controller, since that performed the best in the simulation. Under these parameters, TurKontrol-workflows ran an average of 6.25 iterations with an average of 2.32 ballots per iteration, costing about 46 cents per image description on average.

TurKit's original fixed policy for ballots was used, which requests a third ballot if the first two voters disagree. The number of iterations for TurKit were computed so that the total money spent matched TurKontrol's. Since this number came to be 6.47, three cases were used for comparison: TurKit₆ with 6 iterations, TurKit₇ with 7 iterations and TurKit₆₇ a weighted average of the two that equalized monetary consumption.

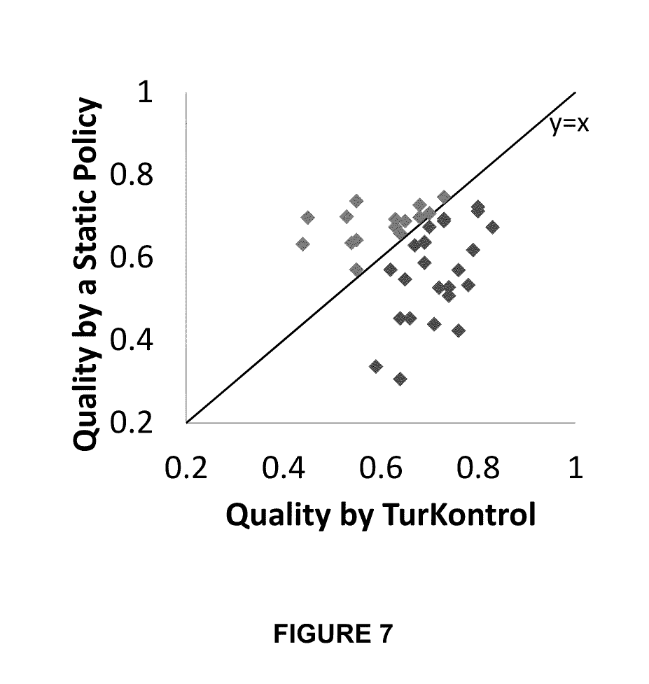

For each final description, a scoring task was created in which multiple workers scored the descriptions. FIG. 7 shows average artifact qualities of 40 descriptions generated by TurKontrol and by TurKit respectively, under the same monetary consumption. FIG. 7 also shows that TurKontrol generated statistically significant higher-quality descriptions than TurKit. Most points are below the γ=x line, indicating that the dynamic workflow produced superior descriptions. Furthermore, the quality produced by TurKontrol was greater on average than TurKit's, and the difference was statistically significant: p<0.01 for TurKit₆, p<0.01 for TurKit₆₇ and p<0.05 for TurKit₇, using the student's t-test.

Using the learned parameters, TurKontrol generated some of the highest-quality descriptions with an average quality of 0.67. TurKit₆₇'s average quality was 0.60; furthermore, it generated the two worst descriptions with qualities below 0.3. Finally, the standard deviation for TurKontrol was much lower (0.09) than TurKit's (0.12). These results demonstrated overall superior performance of decision-theoretic control on live, crowd-sourced workflows.

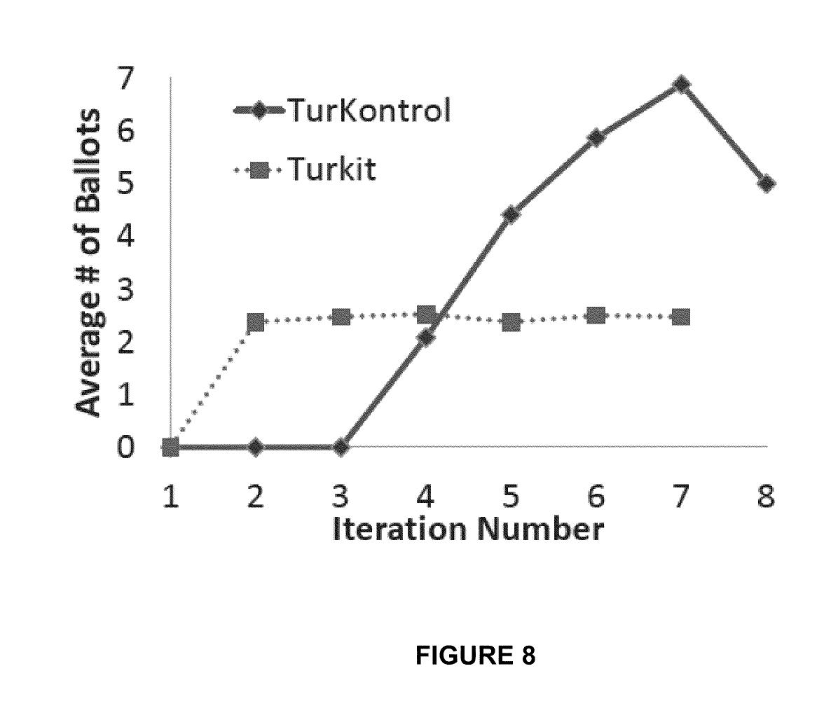

TurKontrol's behavior was qualitatively compared to TurKit's as well and an interesting difference in the use of ballots was found. FIG. 8 plots the average number of ballots per iteration number for TurKontrol and TurKit. Since TurKit's ballot policy was fixed, it always used about 2.45 ballots per iteration. TurKontrol, on the other hand, used ballots much more intelligently. In the first two improvement iterations, TurKontrol did not bother with ballots because it expected that most workers would improve the artifact. As iterations increased, TurKontrol increased its use of ballot jobs, because the artifacts were harder to improve in later iterations, and hence TurKontrol needed more information before deciding which artifact to promote to the next iteration. The eighth iteration was an interesting exception; at this point improvements had become so rare that if even the first voter rated the new artifact as a loser, then TurKontrol often believed the verdict.

Besides using ballots intelligently, TurKontrol added two other kinds of reasoning. First, six of the seven pictures that TurKontrol finished in 5 iterations had higher qualities than TurKit's. This suggested that its quality tracking was working well. Perhaps due to the agreement among various voters, TurKontrol was able to infer that a description already had quality high enough to warrant termination. Secondly, TurKontrol had the ability to track individual workers, and this also affected its posterior calculations. For example, in one instance TurKontrol decided to trust the first vote because that worker had superior accuracy as reflected in a low error parameter. For repetitive tasks, this will be an enormously valuable ability, since TurKontrol will be able to construct more informed worker models and take much superior decisions.

### IV. Example 4

Example 4 is an embodiment involving a crowd-sourced workflow comprising a content task, an evaluation task, and a utility function. In some embodiments, the content task requires a worker to generate an artifact, and the evaluation task requires a worker to evaluate at least one artifact. The workflow may have three decision points: a first decision point preceding the content task, a second decision point following the content task, and a third decision point following the evaluation task. Each decision point may involve the choice of (a) posting a call for at least one worker to complete at least one instance of a next content task, (b) posting a call for at least one worker to complete at least one instance of a next evaluation task, or (c) submitting an artifact as output.

In some variations, an instance of the content task may present a worker with a prior artifact and request that the worker generate an improved artifact with a higher quality parameter than the quality parameter of the prior artifact. In other variations, an instance of the evaluation task may present a worker with a first artifact and a second artifact and request that the worker vote for the artifact with the higher quality parameter.

In Example 4, each artifact may have a quality parameter that approximates the goodness of the artifact or the difficulty of improving the artifact. Each instance of a task may have a difficulty parameter that varies directly with the quality parameters of artifacts generated or evaluated prior to the task.

In some embodiments, a computing device accesses the workflow. The workflow may be received at the computing device from a requester or other source or may be generated by the computing device.

The computing device may also access a plurality of workers, each of whom is capable of performing content tasks and evaluation tasks. Each worker may have one or more capability parameters. The likelihood that the worker will err on an instance of a task may depend on the worker's capability parameters and on difficulty parameters of the instance of the task. A worker completing an instance of a task may impact the capability parameters of the worker based on the difficulty of the instance of the task and the quality parameter of any artifact generated by completing the instance of the task. A worker without a history of completing instances of content tasks or evaluation tasks may be assigned a predetermined average capability parameter.

The computing device may implement a training phase for a set of the plurality of workers to ascertain capability parameters for each worker using artifacts with known quality parameters and content and evaluation tasks with known difficulty parameters. A training phase may also involve ascertaining average capability parameters to be assigned to first-time workers.

The computing device may implement the crowd-sourced workflow by optimizing and/or selecting user-preferred choices at decision points according to the utility function. In some embodiments, an optimization involves posting a call for workers to complete instances of the content task when at least one available worker is likely to create an artifact with a quality parameter sufficiently greater than either a baseline quality value or a quality parameter of a prior artifact to offset a cost of the instance of the content task. This optimization may also involve posting a call for workers to complete instances of the evaluation task when at least one available worker is likely to correctly evaluate an artifact with a quality parameter sufficiently greater than either a baseline quality value or a quality parameter of a prior artifact to offset a cost of the instance of the evaluation task. This optimization may further involve submitting a terminal artifact as output when available workers are unlikely to create in an instance of the content task an artifact with a quality parameter sufficiently higher than the quality parameter of the terminal artifact to offset a cost of the instance of the content task, and are unlikely to correctly evaluate in an evaluation task an artifact with a quality parameter sufficiently higher than the quality parameter of the terminal artifact to offset a cost of the instance of the evaluation task.

In some embodiments, the computing device then submits a terminal artifact as output.

In some workflow implementations, an instance of the content task may present a first worker with a prior artifact and request that the worker generate an improved artifact with a higher quality parameter than the quality parameter of the prior artifact. Option (b)—posting a call for at least one worker to complete at least one instance of a next evaluation task—may then be chosen at the second decision point. An instance of the evaluation task may then present a second worker with a prior artifact and the improved artifact and request that the second worker vote for the artifact with the higher quality parameter. Option (a)—posting a call for at least one worker to complete at least one instance of a next content task—may then be chosen at the third decision point. The voted-for artifact (from the evaluation task)—that is, the artifact with the higher quality parameter—may then become the prior artifact in an instance of the content task.

In some embodiments, the content task may have a price to be paid to a worker who performs an instance of the content task, and the evaluation task has a price to be paid to a worker who performs an instance of the evaluation task. Aggregate task costs may comprise a total of all prices paid to all workers who complete instances of tasks during the implementation of the workflow, and the utility function may describe a relationship between an expected quality and aggregate task costs.

The workflow implemented in an optimized and/or user-preferred manner may be a subset of a larger or more complicated workflow. For example, a directive may be to generate a quality transcription of an audio file. An initial task for such a directive may be to parse the audio file into several coherent and approximately equal-sized pieces. A content-evaluation workflow, such as the one described above in Example 4, may then be implemented as to each piece of the audio file. The content task may be to produce a transcription of the assigned piece, and the evaluation task may be to rate the quality of previously generated transcriptions. In such a scenario, submitting output may involve combining a quality transcription of a piece of the audio file with quality transcriptions of other pieces of the audio file.

### V. Example Computing Device

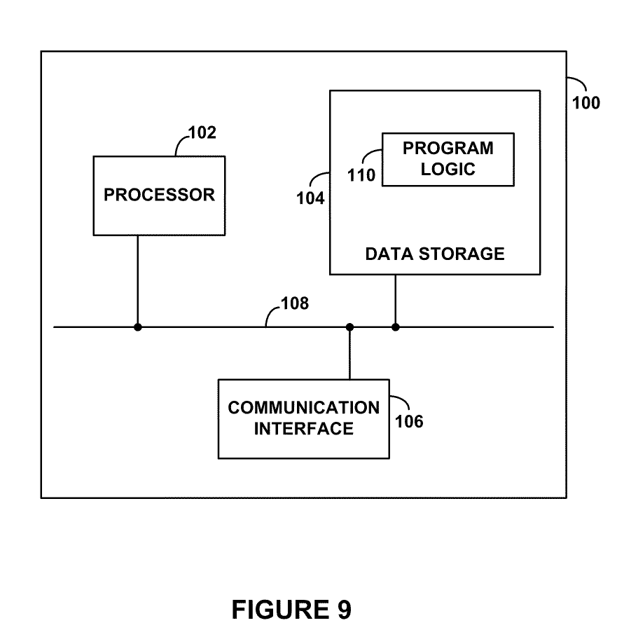

FIG. 9 is a block diagram of an example computing device 100 capable of implementing the embodiments described above and other embodiments. Example computing device 100 includes a processor 102, data storage 104, and a communication interface 106, all of which may be communicatively linked together by a system bus, network, or other mechanism 108. Processor 102 may comprise one or more general purpose processors (e.g., INTEL microprocessors) or one or more special purpose processors (e.g., digital signal processors, etc.) Communication interface 106 may allow data to be transferred between processor 102 and input or output devices or other computing devices, perhaps over an internal network or the Internet. Instructions and/or data structures may be transmitted over the communication interface 106 via a propagated signal on a propagation medium (e.g., electromagnetic wave(s), sound wave(s), etc.). Data storage 104, in turn, may comprise one or more storage components or physical and/or non-transitory computer-readable media, such as magnetic, optical, or organic storage mechanisms, and may be integrated in whole or in part with processor 102. Data storage 104 may contain program logic 110.

Program logic 110 may comprise machine language instructions or other sorts of program instructions executable by processor 102 to carry out the various functions described herein. For instance, program logic 110 may define logic executable by processor 102, to receive, map, or generate workflows, to access a plurality of workers, to implement workflows, and to submit output. In alternative embodiments, it should be understood that these logical functions can be implemented by firmware or hardware, or by any combination of software, firmware, and hardware.

Exemplary embodiments of the invention have been described above. Those skilled in the art will understand, however, that changes and modifications may be made to the embodiments described without departing from the true scope and spirit of the invention. For example, the depicted flow charts may be altered in a variety of ways. For instance, the order of the steps may be rearranged, steps may be performed in parallel, steps may be omitted, or other steps may be included. Accordingly, the disclosure is not limited except as by the appended claims.

1. A decision-theoretic method for controlling crowd-sourced workflows, comprising:
mapping by a computing device a workflow to complete a directive, wherein the directive comprises an input specification, an output specification, and a utility function, wherein the workflow comprises an ordered task set, wherein the task set comprises at least one task, wherein an artifact is generated when a worker completes an instance of a task, wherein the task set transforms input from the input specification into output that complies with the output specification, wherein a decision point precedes and follows each task in the task set, and wherein each decision point comprises at least one of the options of (a) posting a call for at least one worker to complete at least one instance of at least one task in the task set; (b) adjusting at least one parameter of at least one task in the task set; and (c) submitting at least one artifact generated by at least one worker completing at least one instance of at least one task as output;
accessing by the computing device a plurality of workers, wherein each worker is capable of performing tasks, wherein each worker has at least one capability parameter, wherein the at least one capability parameter describes the worker's ability to complete tasks, and wherein the at least one capability parameter is updated after the worker completes an instance of a task;
implementing at the computing device the workflow by optimizing choices at decision points according to the utility function and based on availability of the plurality of workers, the capability parameters of the plurality of workers, and previously generated artifacts; and
submitting at least one artifact generated by at least one worker completing at least one instance of at least one task as output.

2. The method of claim 1, wherein each artifact has a quality parameter.

3. The method of claim 2, wherein the quality parameter of an artifact approximates the goodness of the artifact, wherein a task has a difficulty parameter that varies directly with the quality parameters of artifacts generated or evaluated prior to the task, and wherein the difficulty parameter impacts how the at least one capability parameter of a worker is updated after the worker completes the task.

4. The method of claim 2, further comprising implementing a training phase for a set of the plurality of workers to ascertain capability parameters for each worker using artifacts with known quality parameters and tasks with known difficulty parameters.

5. The method of claim 4, wherein the training phase determines an average capability parameter, and wherein a worker without a history of completing tasks is assigned a predetermined average capability parameter.

6. The method of claim 1, further comprising receiving at the computing device the directive from a crowd-sourcing requester, and wherein the submitting at least one artifact generated by at least one worker completing at least one instance of at least one task as output comprises submitting the artifact to the crowd-sourcing requester.

7. The method of claim 1, wherein a task in the task set has a price to be paid to a worker who performs an instance of the task, wherein aggregate task costs comprise a total of all prices paid to all workers who are assigned instances of tasks to complete, and wherein the utility function describes a relationship between an expected quality and the aggregate task costs.

8. The method of claim 7, wherein the price of a task is a parameter of the task that is adjusted at a decision point.

9. The method of claim 1, wherein the directive comprises a Partially Observable Markov Decision Process (POMDP).

10. The method of claim 1, wherein a decision point is revisited during the implementation of the workflow, and wherein a different choice is made at each occurrence of the decision point.

11. The method of claim 1, wherein the at least one capability parameter of a worker is updated after each time an instance of a task is completed by the worker.

12. The method of claim 1, wherein the at least one capability parameter of a worker is updated periodically as instances are completed by the worker.

13. The method of claim 1, wherein optimizing choices at decision points according to the utility function comprises trading off a gain in long-term expected quality with an immediate cost incurred by choosing an option at a decision point.

14. A decision-theoretic method for controlling crowd-sourced workflows, comprising:
accessing at a computing device a crowd-sourced workflow comprising a content task, an evaluation task, and a utility function, wherein the content task requires a worker to generate an artifact, wherein the evaluation task requires a worker to evaluate at least one artifact, wherein a first decision point precedes the content task, wherein a second decision point follows the content task, wherein a third decision point follows the evaluation task, wherein each decision point comprises choosing (a) to post a call for at least one worker to complete at least one instance of a next content task, (b) to post a call for at least one worker to complete at least one instance of a next evaluation task, or (c) to submit an artifact as output, wherein each artifact has a quality parameter that approximates the goodness of the artifact, and wherein an instance of a task has a difficulty parameter that varies directly with the quality parameters of artifacts generated or evaluated prior to the task;
accessing by the computing device a plurality of workers, wherein a worker is capable of performing content tasks and evaluation tasks, wherein the worker has a capability parameter, and wherein the likelihood that the worker will err on an instance of a task depends on the capability parameter and on the difficulty parameter of the instance of the task;
implementing at the computing device the crowd-sourced workflow by optimizing choices at decision points according to the utility function such that (i) an instance of the content task is performed when an available worker is likely to create an artifact with a quality parameter sufficiently greater than either a baseline quality value or a quality parameter of a prior artifact to offset a cost of the instance of the content task, (ii) an instance of the evaluation task is performed when an available worker is likely to correctly evaluate an artifact with a quality parameter sufficiently greater than either a baseline quality value or a quality parameter of a prior artifact to offset a cost of the instance of the evaluation task, and (iii) a terminal artifact is submitted as output when an available worker is unlikely to create in an instance of the content task an artifact with a quality parameter sufficiently higher than the quality parameter of the terminal artifact to offset a cost of the instance of the content task, and is unlikely to correctly evaluate in an evaluation task an artifact with a quality parameter sufficiently higher than the quality parameter of the terminal artifact to offset a cost of the instance of the evaluation task; and
submitting by the computing device a terminal artifact as output,
wherein a worker completing an instance of a task impacts the capability parameter of the worker based on the difficulty of the instance of the task and the quality parameter of any artifact generated by completing the instance of the task.

15. The method of claim 14, wherein an instance of the content task presents a worker with a prior artifact and requests that the worker generate an improved artifact with a higher quality parameter than the quality parameter of the prior artifact.

16. The method of claim 14, wherein an instance of the evaluation task presents a worker with a first artifact and a second artifact and requests that the worker vote for the artifact with the higher quality parameter.

17. The method of claim 14, wherein an instance of the content task presents a first worker with a prior artifact and requests that the worker generate an improved artifact with a higher quality parameter than the quality parameter of the prior artifact, wherein option (b) is chosen at the second decision point, and wherein an instance of the evaluation task presents a second worker with a prior artifact and an improved artifact and requests that the second worker vote for the artifact with the higher quality parameter.

18. The method of claim 17, wherein option (a) is chosen at the third decision point, and wherein the artifact with the higher quality parameter becomes the prior artifact in an instance of the content task.

19. The method of claim 14, wherein the content task has a price to be paid to a worker who performs an instance of the content task, wherein the evaluation task has a price to be paid to a worker who performs an instance of the evaluation task, wherein aggregate task costs comprise a total of all prices paid to all workers who complete instances of tasks, and wherein the utility function describes a relationship between an expected quality and aggregate task costs

20. The method of claim 14, wherein a worker without a history of completing instances of content tasks or evaluation tasks is assigned a predetermined average capability parameter.

21. The method of claim 14, further comprising implementing a training phase for a set of the plurality of workers to ascertain capability parameters for each worker using artifacts with known quality parameters and content and evaluation tasks with known difficulty parameters.

22. The method of claim 14, wherein at least one decision point is revisited during the implementation of the workflow, and wherein a different choice is made at each occurrence of the decision point.

23. A physical computer-readable storage medium containing instructions executable by a processor that, when executed, cause the processor to perform the following functions:
map a workflow to complete a directive, wherein the directive comprises an input specification, an output specification, and a utility function, wherein the workflow comprises an ordered task set, wherein the task set comprises at least one task, wherein an artifact is generated when a worker completes an instance of a task, wherein the task set transforms input from the input specification into output that complies with the output specification, wherein a decision point precedes and follows each task in the task set, and wherein each decision point comprises at least one of the options of (a) posting a call for at least one worker to complete at least one instance of at least one task in the task set; (b) adjusting at least one parameter of at least one task in the task set; and (c) submitting at least one artifact generated by at least one worker completing at least one instance of at least one task as output;
access a plurality of workers, wherein each worker is capable of performing tasks, wherein each worker has at least one capability parameter, wherein the at least one capability parameter describes the worker's ability to complete tasks, and wherein the at least one capability parameter is updated after the worker completes an instance of a task;
implement the workflow by optimizing choices at decision points according to the utility function and based on availability of the plurality of workers, the capability parameters of the plurality of workers, and the previously generated artifacts; and
submit at least one artifact generated by at least one worker completing at least one instance of at least one task as output.

24. The computer-readable medium of claim 23, wherein the functions further comprise to implement a training phase for a set of the plurality of workers to ascertain capability parameters for each worker using artifacts with known quality parameters and tasks with known difficulty parameters.

25. The computer-readable medium of claim 23, wherein the optimizing choices at decision points according to the utility function comprises trading off a gain in long-term expected quality with an immediate cost incurred by choosing an option at a decision point.
